(19) United States
(12) Patent Application Publication
(10) Pub. No.: US 2016/0364663 A1
(43) Pub. Date: Dec. 15, 2016

(54) RISK-ASSESSMENT BASED DECISION SUPPORT SYSTEM FOR STRATEGIC PRODUCT LOCALIZATION

(71) Applicant: CA, Inc., New York, NY (US)

(72) Inventors: Smrati Gupta, Barcelona (ES); Victor Muntes, Barcelona (ES); Peter Brian Matthews, Berkhamsted (GB); Jacek Dominiak, Barcelona (ES); Patricia Paladini Adell, Sant Cugat del Valles (ES)

(73) Assignee: CA, Inc.

(21) Appl. No.: 14/736,774

(22) Filed: Jun. 11, 2015

(51) Int. Cl. G06Q 10/06; G06Q 30/02

(52) U.S. Cl. CPC G06Q 10/0635; G06Q 30/0205

(57) ABSTRACT

A method includes performing operations as follows on a processor: receiving a description of a plurality of products, each product in the plurality of products having a local geographic feature that is configurable in one of a plurality of geographic configurations, receiving a description of priorities associated with the plurality of products, generating a risk based on the priorities, generating a risk mitigating treatment based on the risk, generating, for each of the plurality of products, a plurality of product localization scores corresponding to the plurality of geographic configurations, respectively, each of the plurality of product localization scores indicating a relative amount of the risk mitigated by the risk mitigating treatment with the local geographic feature having the respective geographic configuration, generating a plurality of global localization scores based on the plurality of product localization scores, each of the plurality of global localization scores corresponding to the plurality of products having one of a plurality of combinations of the geographic configurations, and determining how to configure the local geographic feature for each of the plurality of products based on the plurality of global localization scores.

### BACKGROUND

The present disclosure relates to computing systems, and, in particular, to methods, systems, and computer program products for determining how to configure products for a localized geographic region based on priorities provided by multiple stakeholders and assessment of risk.

The global expansion of the software industry has led to an increase in the use of various software products in many divergent countries and cultures. This may create an increased need for localization of products by any enterprise that wishes to do business those countries and cultures. The need to localize products has generally increased, particularly in the software industry, in the past decade. Product localization may be defined as configuring one or more product features based on the target locale (e.g., geographic region and/or language) where the (e.g., geographic region and/or language) product is used and/or sold. One example of product localization is to make a product linguistically and culturally appropriate to a target locale. Many different factors may be involved in determining whether to invest resources in configuring a product so that it is localized for a particular locale. Many enterprises make this decision using a cost-benefit analysis based on the potential marketability of the product and the costs associated with localization.

### SUMMARY

In some embodiments of the inventive subject matter, a method comprises performing operations as follows on a processor: receiving a description of a plurality of products, each product in the plurality of products having a local geographic feature that is configurable in one of a plurality of geographic configurations; receiving a description of priorities associated with the plurality of products; generating a risk based on the priorities; generating a risk mitigating treatment based on the risk; generating, for each of the plurality of products, a plurality of product localization scores corresponding to the plurality of geographic configurations, respectively, each of the plurality of product localization scores indicating a relative amount of the risk mitigated by the risk mitigating treatment with the local geographic feature having the respective geographic configuration; generating a plurality of global localization scores based on the plurality of product localization scores, each of the plurality of global localization scores corresponding to the plurality of products having one of a plurality of combinations of the geographic configurations; and determining how to configure the local geographic feature for each of the plurality of products based on the plurality of global localization scores.

In other embodiments of the inventive subject matter, a system comprises a processor and a memory coupled to the processor, which comprises computer readable program code embodied in the memory that when executed by the processor causes the processor to perform operations comprising: receiving a description of a plurality of products, each product in the plurality of products having a local geographic feature that is configurable in one of a plurality of geographic configurations; receiving a description of priorities associated with the plurality of products; generating a risk based on the priorities; generating a risk mitigating treatment based on the risk; generating, for each of the plurality of products, a plurality of product localization scores corresponding to the plurality of geographic configurations, respectively, each of the plurality of product localization scores indicating a relative amount of the risk mitigated by the risk mitigating treatment with the local geographic feature having the respective geographic configuration; generating a plurality of global localization scores based on the plurality of product localization scores, each of the plurality of global localization scores corresponding to the plurality of products having one of a plurality of combinations of the geographic configurations; and determining how to configure the local geographic feature for each of the plurality of products based on the plurality of global localization scores.

In still other embodiments of the inventive subject matter, a computer program product comprises a tangible computer readable storage medium comprising computer readable program code embodied in the medium that when executed by a processor causes the processor to perform operations comprising: receiving a description of a plurality of products, each product in the plurality of products having a local geographic feature that is configurable in one of a plurality of geographic configurations; receiving a description of priorities associated with the plurality of products; generating a risk based on the priorities; generating a risk mitigating treatment based on the risk; generating, for each of the plurality of products, a plurality of product localization scores corresponding to the plurality of geographic configurations, respectively, each of the plurality of product localization scores indicating a relative amount of the risk mitigated by the risk mitigating treatment with the local geographic feature having the respective geographic configuration; generating a plurality of global localization scores based on the plurality of product localization scores, each of the plurality of global localization scores corresponding to the plurality of products having one of a plurality of combinations of the geographic configurations; and determining how to configure the local geographic feature for each of the plurality of products based on the plurality of global localization scores.

It is noted that aspects described with respect to one embodiment may be incorporated in different embodiments although not specifically described relative thereto. That is, all embodiments and/or features of any embodiments can be combined in any way and/or combination. Moreover, other methods, systems, articles of manufacture, and/or computer program products according to embodiments of the inventive subject matter will be or become apparent to one with skill in the art upon review of the following drawings and detailed description. It is intended that all such additional systems, methods, articles of manufacture, and/or computer program products be included within this description, be within the scope of the present inventive subject matter, and be protected by the accompanying claims. It is further intended that all embodiments disclosed herein can be implemented separately or combined in any way and/or combination.

### BRIEF DESCRIPTION OF THE DRAWINGS

Other features of embodiments will be more readily understood from the following detailed description of specific embodiments thereof when read in conjunction with the accompanying drawings, in which:

FIG. 1 is a block diagram of a decision support system for determining how to configure a product for localization to a geographic region in accordance with some embodiments of the inventive subject matter;

FIG. 2 illustrates a data processing system that may be used to implement the localization strategy advisor system of FIG. 1 in accordance with some embodiments of the inventive subject matter;

FIG. 3 is a block diagram that illustrates a software/hardware architecture for determining how to configure a product for localization to a geographic region in accordance with some embodiments of the present inventive subject matter;

FIG. 4 is a flowchart that illustrates operations for determining how to configure a product for localization to a geographic region in accordance with some embodiments of the inventive subject matter;

FIGS. 5-8 are computer display screenshots that illustrate a user interface of a decision support system for determining how to configure a product for localization to a geographic region in accordance with some embodiments of the inventive subject matter;

FIG. 9 is a flowchart that illustrates further operations for determining how to configure a product for localization to a geographic region in accordance with some embodiments of the inventive subject matter;

FIG. 10 is a further computer display screen shot that illustrates the user interface of a decision support system for determining how to configure a product for localization to a geographic region in accordance with some embodiments of the inventive subject matter; and

FIG. 11 is a chart that illustrates example configurations for localizing three products in accordance with some embodiments of the inventive subject matter.

### DETAILED DESCRIPTION

In the following detailed description, numerous specific details are set forth to provide a thorough understanding of embodiments of the present disclosure. However, it will be understood by those skilled in the art that the present invention may be practiced without these specific details. In some instances, well-known methods, procedures, components and circuits have not been described in detail so as not to obscure the present disclosure. It is intended that all embodiments disclosed herein can be implemented separately or combined in any way and/or combination. Aspects described with respect to one embodiment may be incorporated in different embodiments although not specifically described relative thereto. That is, all embodiments and/or features of any embodiments can be combined in any way and/or combination.

As used herein, a “service” includes, but is not limited to, a software and/or hardware service, such as cloud services in which software, platforms, and infrastructure are provided remotely through, for example, the Internet. A service may be provided using Software as a Service (SaaS), Platform as a Service (PaaS), and/or Infrastructure as a Service (IaaS) delivery models. In the SaaS model, customers generally access software residing in the cloud using a thin client, such as a browser, for example. In the PaaS model, the customer typically creates and deploys the software in the cloud sometimes using tools, libraries, and routines provided through the cloud service provider. The cloud service provider may provide the network, servers, storage, and other tools used to host the customer's application(s). In the IaaS model, the cloud service provider provides physical and/or virtual machines along with hypervisor(s). The customer installs operating system images along with application software on the physical and/or virtual infrastructure provided by the cloud service provider.

As used herein, the term “data processing facility” includes, but it not limited to, a hardware element, firmware component, and/or software component. A data processing system may be configured with one or more data processing facilities.

Some embodiments of the inventive subject matter stem from a realization that configuring a product for localization to a geographic region may be an intensive investment for an enterprise. A number of priorities may be taken into consideration including both technical and market priorities. These priorities, for example, may include, but are not limited to, revenue generation, compliance with legal regulations, customer loyalty, quality, and/or product maturity level. A myriad of priorities may be taken into consideration before deciding how to configure a product for use/sale in a particular locale. These priorities may be provided by sources with different perspectives, e.g., marketing and technical sources, and may be subject to a wide range of considerations, such as state of product life-cycle, level of adoption of technology, responsiveness within a region, political/jurisdiction conditions, etc. In addition, for a large enterprise having multiple products, the overall localization of each product may be influenced by the localization strategy of different products together. For example, assuming a constraint of having a limited budget for localization, a desired localization strategy may be chosen that involves localizing certain features of one or more products while not localizing other features of one or more products taking into account the global strategy of the enterprise. When choosing to localize a product, several levels or segments of localization may be possible. For example, in the case of a software product, three different local geographic features may be configured to localize a product: a user interface for the software product, user support for the software product, and product documentation for the software product. The geographic configuration may be a particular human communication language of multiple language options that the feature is translated into. Thus, level three localization may be performing a translation for all three features (user interface, user support, product documentation), level two localization may be performing a translation for two of the three features, while level one localization may be performing a translation for one of the three features.

Some embodiments of the inventive subject matter may provide a Decision Support System (DSS) for determining how to configure a product for localization to a geographic region. The DSS may accept as input as description of market and/or technical priorities along with a description of a portfolio of products. Thus, the description of priorities may include the perspectives of personnel with marketing, financial, legal, and technical perspectives. The technical perspectives may include both engineer/scientist perspectives as well as linguist perspectives. The DSS may take into account the joint effect of these priorities using a risk-based methodology. Risks may be assessed and a localization strategy may be developed in terms of how to configure the products for localization to mitigate the identified risks.

For ease of description, a non-limiting example is described herein in which the products to be localized are software products and the local geographic features that are configurable to localize the software products comprise a user interface, user support, and product documentation. Each of these features may be localized through translation to one of a plurality of human communication languages. It will be understood, however, that embodiments of the inventive subject matter are not limited to such products and/or local geographic features as the DSS for determining how to configure a product for localization to a geographic region described herein can be used with other types of products and/or configurable local geographic features.

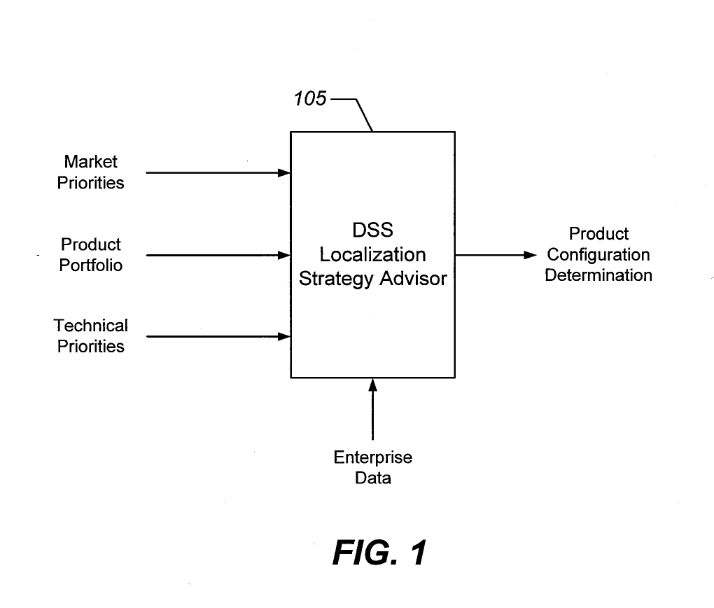

FIG. 1 is a block diagram of a DSS for determining how to configure a product for localization to a geographic region in accordance with some embodiments of the inventive subject matter. A DSS Localization Strategy Advisor data processing system 105 is configured to receive input information including a description of a product portfolio including a plurality of products along with a description of priorities associated with the plurality of products. Each of the products may have a plurality of local geographic features, each of which is configurable in one of a plurality of geographic configurations where the plurality of geographic configurations comprises a plurality of human communication languages. The local geographic features may comprise, for example, a user interface, user support, and/or product documentation. The description of the priorities may comprise a description of market priorities associated with the plurality of products and/or a description of technical priorities associated with the plurality of products. In accordance with some embodiments of the inventive subject matter, the market priorities comprise product revenue, return on investment, customer loyalty, market reputation, and/or legal compliance. The technical priorities may comprise quality of end user experience, difficulty of changing the local geographic feature from one of the plurality of geographic configurations to another one of the plurality of geographic configurations, and/or product maturity level.

The DSS localization strategy advisor data processing system 105 may be further configured to receive enterprise data and/or information associated with the particular markets/geographic regions where localization decisions are to be made for the products in the product portfolio. Examples of these data/information may include, but are not limited to, expected investment in product localization, revenue generated from a product in a particular market in a past financial year, user feedback on a product translated into a particular language, market leadership (yes/no), predicted revenue immediate, predicted revenue long term, maturity level, investment required for each level of localization (e.g., user interface, user support, and/or product documentation), market saturation (yes/no), and the like.

The DSS localization strategy advisor data processing system 105 may determine a product configuration, e.g., how to configure the local geographic feature for one or more of the plurality of products taking into account the multiple perspectives provided through the market and technical priorities along with the enterprise data/information using a risk based methodology designed to mitigate the identified risks.

Although FIG. 1 illustrates a decision support system for determining how to configure a product for localization to a geographic region in accordance with some embodiments of the inventive subject matter it will be understood that embodiments of the present invention are not limited to such configurations, but are intended to encompass any configuration capable of carrying out the operations described herein.

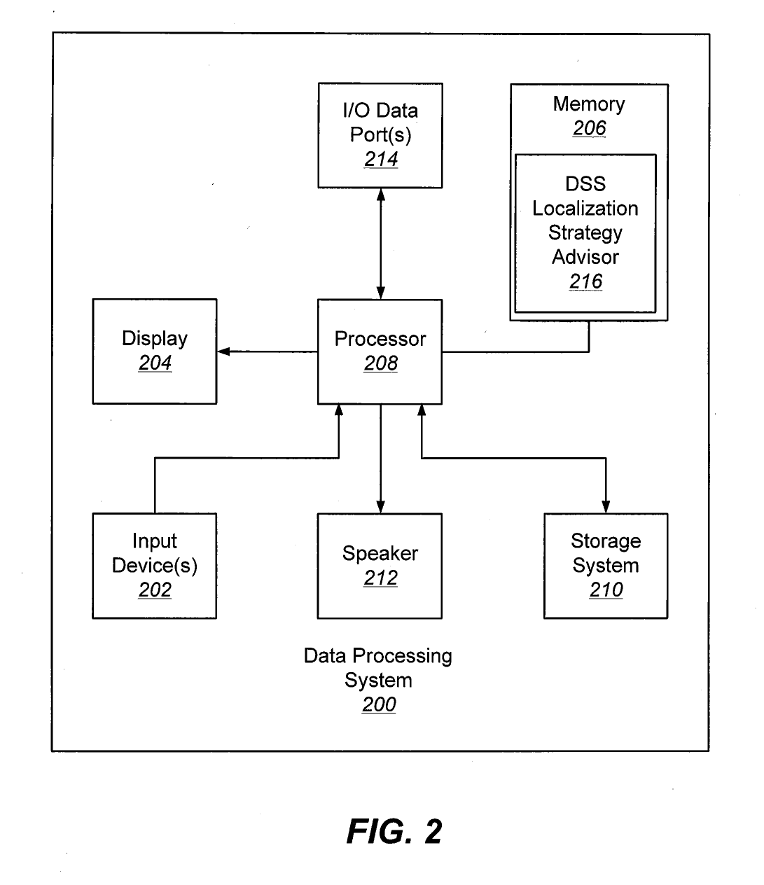

Referring now to FIG. 2, a data processing system 200 that may be used to implement the DSS localization strategy advisor data processing system 105 of FIG. 1, in accordance with some embodiments of the inventive subject matter, comprises input device(s) 202, such as a keyboard or keypad, a display 204, and a memory 206 that communicate with a processor 208. The data processing system 200 may further include a storage system 210, a speaker 212, and an input/output (I/O) data port(s) 214 that also communicate with the processor 208. The storage system 210 may include removable and/or fixed media, such as floppy disks, ZIP drives, hard disks, or the like, as well as virtual storage, such as a RAMDISK. The I/O data port(s) 214 may be used to transfer information between the data processing system 200 and another computer system or a network (e.g., the Internet). These components may be conventional components, such as those used in many conventional computing devices, and their functionality, with respect to conventional operations, is generally known to those skilled in the art. The memory 206 may be configured with a DSS Localization Strategy Advisor module 216 that may provide functionality that may include, but is not limited to, determining how to configure a product for localization to a geographic region.

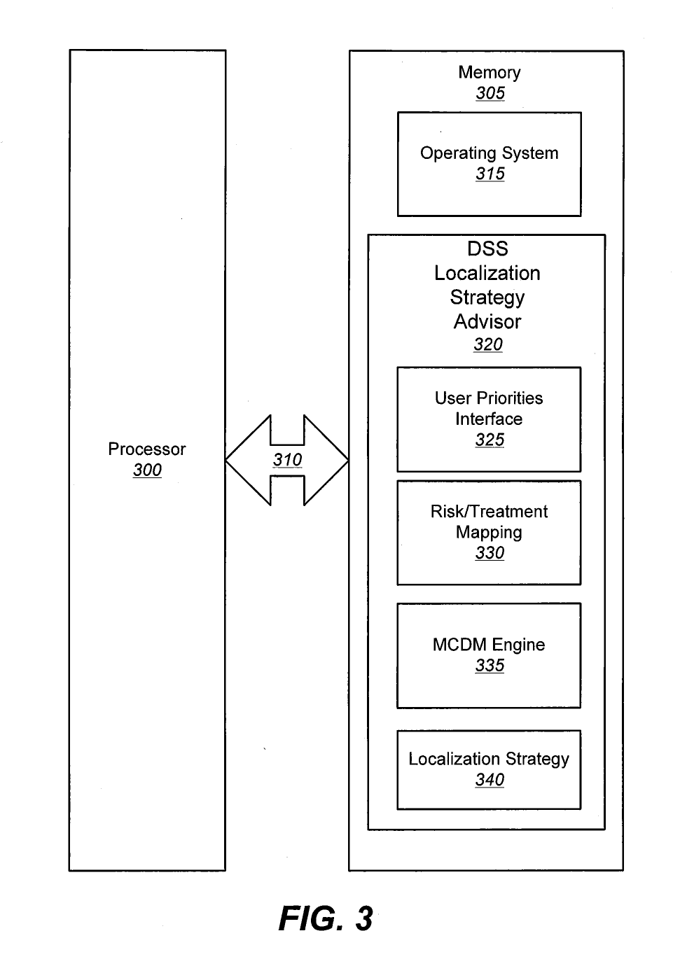

FIG. 3 illustrates a processor 300 and memory 305 that may be used in embodiments of data processing systems, such as the data processing system 200 of FIG. 2, respectively, for determining how to configure a product for localization to a geographic region according to some embodiments of the inventive subject matter. The processor 300 communicates with the memory 305 via an address/data bus 310. The processor 300 may be, for example, a commercially available or custom microprocessor. The memory 305 is representative of the one or more memory devices containing the software and data used for determining how to configure a product for localization to a geographic region in accordance with some embodiments of the inventive subject matter. The memory 305 may include, but is not limited to, the following types of devices: cache, ROM, PROM, EPROM, EEPROM, flash, SRAM, and DRAM.

As shown in FIG. 3, the memory 305 may contain two or more categories of software and/or data: an operating system 315 and a DSS Localization Strategy Advisory module 320. In particular, the operating system 315 may manage the data processing system's software and/or hardware resources and may coordinate execution of programs by the processor 300. The DSS Localization Strategy Advisory module 320 may comprise a user priorities interface module 325, a risk/treatment mapping module 330, a Multi-Criteria Decision Making (MCDM) engine 335, and a localization strategy module 340. The user priorities interface module 325 may be configured to facilitate the ability for members of an enterprise to express their priorities when determining how to configure a product for localization to a geographic region. These members can be, for example, business executives, sales executives, localization team leaders/members, software developers, hardware developers, and the like. In some embodiments of the inventive subject matter, three types of information/data may be received via the user priorities interface 325: a description of a product portfolio, a description of market priorities, and a description of technical priorities. The product portfolio may include a description of a plurality of products intended for consideration for localization to a geographic region. The product portfolio may include a single product or multiple products depending on the enterprise's strategy for the particular region. The market priorities may comprise product revenue, return on investment, customer loyalty, market reputation, and/or legal compliance. The technical priorities may comprise quality of end user experience, difficulty of changing the local geographic feature from one of the plurality of geographic configurations to another one of the plurality of geographic configurations, and/or product maturity level. The maturity level of a product may be of particular concern when considering localization within a more limited time span. For a product with a lower maturity level, the localization configuration process may be more complex as compared with a product with a higher maturity level.

The risk/treatment mapping module 330 may be configured to map the priorities for the product portfolio input through the user priorities interface module 325 to the expected risks that these priorities are subjected to. Such risks may include, but are not limited to, breach of legal compliance, loss in customer trust, loss in brand name, loss in revenue in immediate financial year, loss in revenue in future financial years, and investment in a saturated market. As an example, if a user priority is “sales rate,” an expected risk may be “drop in sales rate due to inefficient localization strategy.” A more intricate example may involve the user priority from a business perspective of “customer loyalty” and from a technical perspective “maturity level of the product” (the product typically needs to be mature enough for localization to a geographic region; otherwise the localization costs are usually very high). When a new product is launched, the maturity level is low and localization of the product may involve a large financial investment. However, if the product has a growing customer base in a similar market the anticipated customer loyalty may be high. Therefore, the risks for this product may be “loss of customer trust” and “low return on investment in immediate financial year.”

The risk/treatment mapping module may be further configured to identify what treatments may be used to mitigate the identified risks. These treatments describe properties that may ensure that the priorities are protected from the identified risks. Such treatments may include, but are not limited to, ensure that market leadership is maintained, ensure that expected revenue in immediate financial year is greater than a first threshold, ensure that revenue in future financial years is greater than a second threshold, ensure that investment in configuring the local geographic feature is less than a third threshold, ensure that product maturity level is greater than a fourth threshold, and ensuring that investment in configuring the local geographic feature is less than a fifth threshold in a saturated market. As an example, to mitigate the risk of a “drop in sales rate,” a risk mitigating treatment may ensure that the sales rate is not compromised in the short and/or long term. A more intricate example may involve the risk of “loss in customer trust” and “loss in revenue in immediate financial year” and the risk mitigating treatment may be to ensure that the product maintains market leadership through customer trust through some level of localization (e.g., translation of user interface and user support) while also ensuring that revenue is not compromised in the immediate financial year (e.g., product documentation is not translated).

The mapping of priorities to risks and risks to treatments may be done based on input/feedback from enterprise localization teams and business experts. The mappings may be stored in the DSS Localization Strategy Advisory data processing system 105. When a user inputs technical and/or market priorities into the DSS Localization Strategy Advisory data processing system 105, the associated risks and treatments may be proposed to the user based on the mappings. The user can accept, change, and/or propose new mappings between the priorities, risks, and treatments. Repeated use of the DSS Localization Strategy Advisory data processing system 105 may enable it to learn about previous mappings via automatic learning mechanisms from heuristic data. This may improve risk-treatment mapping for inexperienced users. The DSS Localization Strategy Advisory data processing system 105 may also supply a framework for automatic development of risk-treatment mapping.

The MCDM engine module 335 may be configured to generate, for each of the products in the product portfolio, a plurality of product localization scores corresponding to the plurality of geographic configurations, respectively. Each of the product localization scores is indicative of a relative amount of risk mitigated by a risk mitigating treatment when the local geographic feature has a particular geographic configuration. Global localization scores may be generated based on the product localization scores corresponding to the products having various combinations of the geographic configurations. The product localization scores and global localization scores may be generated using various techniques based on the enterprise data/information along with the mapping between priorities, risks, and treatments. Examples of the MCDM methodology may include, but are not limited to, the Analytical Hierarchy Process as described in “Group Decision Making: Drawing out and Reconciling Differences,” by Saaty et al. and/or the Preference Ranking Organization Method for Enrichment Evaluation as described in “A preference ranking organization method: The PROMETHEE method for MCDM,” by Brans et al.

An embodiment of the MCDM methodology may be illustrated by way of example. A user may specify on a scale of 0 to 10 a risk acceptability threshold for each product in each local geographic configuration under consideration (e.g., each language under consideration Spanish, Japanese, etc.). For each risk, the user may specify the likelihood of the risk occurring and the consequence resulting from the risk occurring on a scale of 1 to 5 each. The product of the likelihood and the consequence of a risk may be indicative of the relative importance of the risk and how important it is to mitigate the risk. This product may be normalized to a scale of 1 to 10 from a scale of 1-25 and may be termed an importance of the risk threshold. When the importance of the risk threshold is less than the risk acceptability threshold, then the risk does not require mitigation. Otherwise, one or more treatments may be invoked to mitigate the risk. For each treatment applied to mitigate a risk, different combinations of local geographic configurations may be considered and given a normalized score on a 1-10 scale. For example, if two geographic configurations, Spanish and Japanese are possible for three different local geographic features—user interface, user support, and product documentation—then eight combinations may be considered. The highest revenue combination is assigned a score of 10 and the other combinations are assigned scores relative to the high score. When the score of a particular combination of geographic configurations/features for a risk treatment exceeds the risk acceptability threshold, then the risk may be mitigated by the corresponding treatment. The above-described approach may be repeated for each of the risks and each of the products in the product portfolio to generate product localization scores indicative of a percentage of the total risk mitigated. A global localization score may be an average of the product localization scores for a particular combination of geographic configurations of the products.

The localization strategy module 340 may be configured to determine how to configure the local geographic feature(s) for each of the plurality of products based on the global localization scores generated by the MCDM engine 335. In some embodiments, localization strategy module 340 generates a recommendations list giving the combination geographic configurations for the products along with their product localization scores and global localization score for the entire product portfolio for each combination. The DSS Localization Strategy Advisory data processing system 105 may maintain a history of past priorities, risks, risk mitigation treatments, risk acceptability thresholds, risk likelihoods, risk consequences, and the like to provide inexperienced users with recommendations. This progressive learning property may enable the DSS Localization Strategy Advisory data processing system 105 to evolve and the framework to be self-sustainable.

Although FIG. 3 illustrates hardware/software architectures that may be used in data processing systems, such as the data processing system 200 of FIG. 2 for determining how to configure a product for localization to a geographic region according to some embodiments of the inventive subject matter, it will be understood that the present invention is not limited to such a configuration but is intended to encompass any configuration capable of carrying out operations described herein.

Computer program code for carrying out operations of data processing systems discussed above with respect to FIGS. 1-3 may be written in a high-level programming language, such as Python, Java, C, and/or C++, for development convenience. In addition, computer program code for carrying out operations of the present invention may also be written in other programming languages, such as, but not limited to, interpreted languages. Some modules or routines may be written in assembly language or even micro-code to enhance performance and/or memory usage. It will be further appreciated that the functionality of any or all of the program modules may also be implemented using discrete hardware components, one or more application specific integrated circuits (ASICs), or a programmed digital signal processor or microcontroller.

Moreover, the functionality of the DSS Localization Strategy Advisory data processing system 105, the data processing system 200 of FIG. 2, and hardware/software architecture of FIG. 3, may each be implemented as a single processor system, a multi-processor system, a multi-core processor system, or even a network of stand-alone computer systems, in accordance with various embodiments of the inventive subject matter. Each of these processor/computer systems may be referred to as a “processor” or “data processing system.”

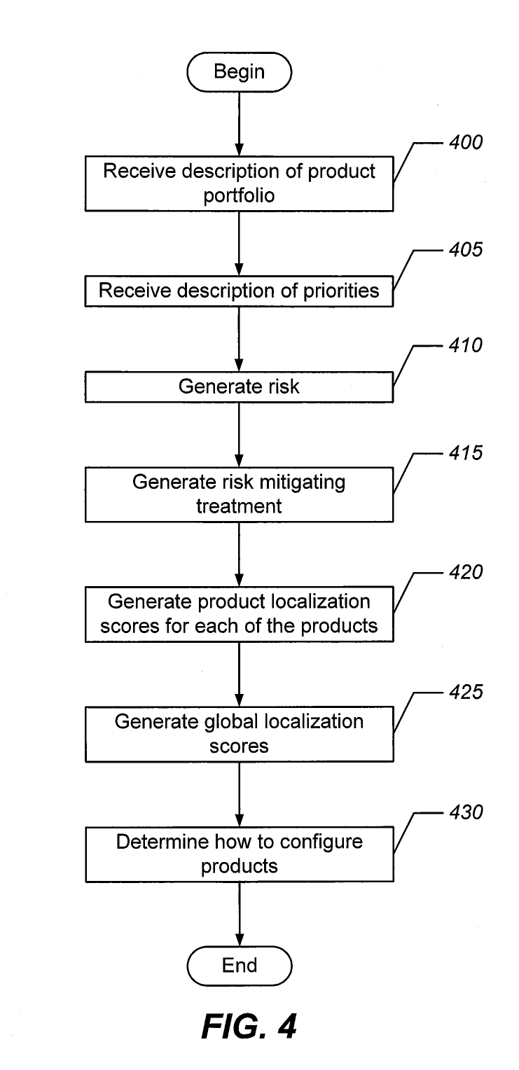

The data processing apparatus of FIGS. 1-3 may be used to determine how to configure a product for localization to a geographic region according to various embodiments described herein. These apparatus may be embodied as one or more enterprise, application, personal, pervasive and/or embedded computer systems and/or apparatus that are operable to receive, transmit, process and store data using any suitable combination of software, firmware and/or hardware and that may be standalone or interconnected by any public and/or private, real and/or virtual, wired and/or wireless network including all or a portion of the global communication network known as the Internet, and may include various types of tangible, non-transitory computer readable media. In particular, the memory 206 coupled to the processor 208 and the memory 305 coupled to the processor 300 include computer readable program code that, when executed by the respective processors, causes the respective processors to perform operations including one or more of the operations described herein with respect to FIGS. 4-11.

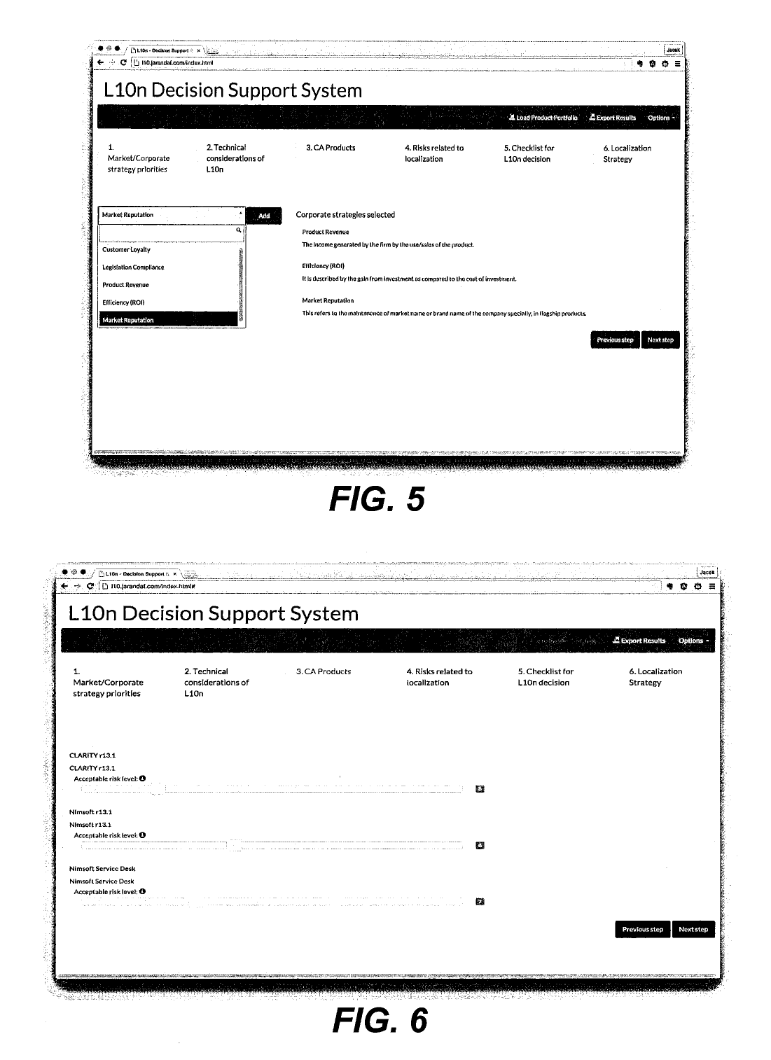

FIG. 4 is a flowchart that illustrates operations for determining how to configure a product for localization to a geographic region in accordance with some embodiments of the inventive subject matter. Referring to FIG. 4, operations begin at block 400 where the DSS Localization Strategy Advisor 105 receives a description of the product portfolio to be considered for localization to a geographic region from one or more users. This is illustrated, for example, in FIG. 6 where three products-CLARITY, Nimsoft, and Nimsoft Service Desk—are entered into the DSS Localization Strategy Advisor 105. At block 405, users may enter a description of priorities associated with the product portfolio, which may include both market and technical priorities as described above. FIG. 5, for example, illustrates the entry of market priorities where the user has selected product revenue, efficiency (ROI), and market reputation. Operations continue at block 410 where one or more risks are generated based on the priorities that have been received. FIG. 7, for example, illustrates two risks that have been selected for the product portfolio, which are legal compliance with a country not met, and loss in customer trust. Based on the risks that have been generated, one or more risk mitigating treatments may be generated at block 415. This is illustrated, for example, in FIG. 8 where various treatments are mapped to associated risks and products in the product portfolio. In the example shown, the risk mitigating treatment of maintain market leadership/flagship is mapped to the risk of loss in customer trust for all three products in the portfolio. The risk treatment of acceptable localization of investment in saturation markets, however, is mapped to the risk of loss in revenue (long term) for only one product in the product portfolio (Nimsoft Service Desk).

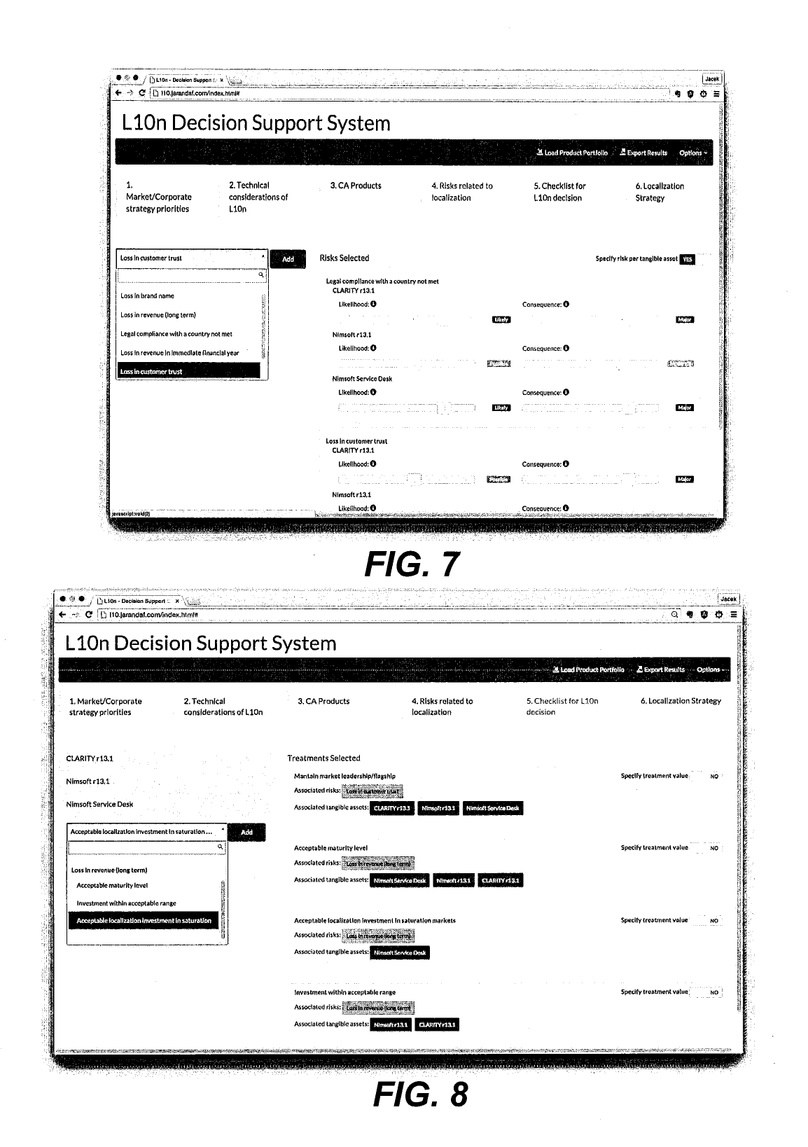

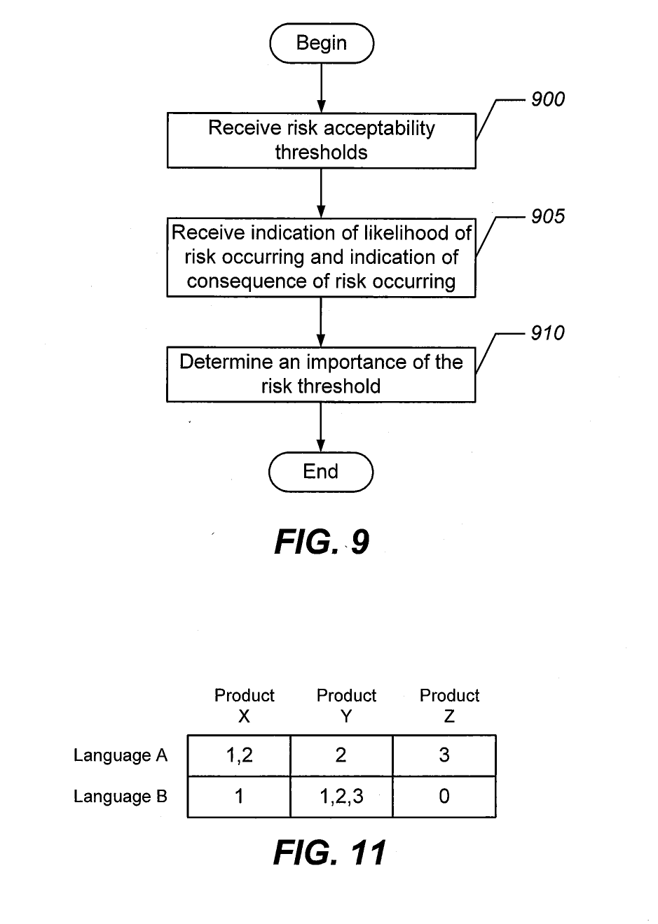

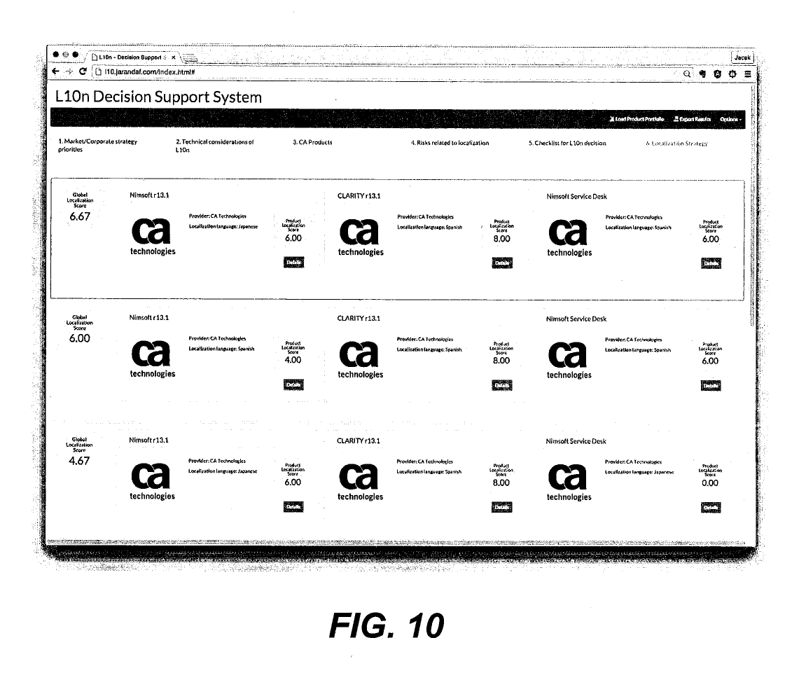

The MCDM engine 335 of the DSS Localization Strategy Advisor 105 may generate product localization scores for each of the products at block 420. Referring now to FIG. 9, as described above with respect to the MCDM engine 335 of FIG. 3, risk acceptability thresholds are received for the products in the product portfolio. This is illustrated, for example, in FIG. 6 where a user may operate a slide interface to indicate the acceptable risk level for each of the products in the product portfolio. The DSS Localization Strategy Advisor 105 may receive indications of the likelihood of a risk occurring and the consequence of the risk occurring for each risk by product at block 905. This is illustrated, for example, in FIG. 7 where a user may operate slide interfaces to indicate the relative likelihood and relative consequence for each risk associated with each product. An importance of the risk threshold may be determined at block 910 based on the likelihood and consequence indications for each risk. In some embodiments, the importance of the risk threshold may be determined by generating the product of the likelihood and consequence indications for each risk. As described above, when the importance of the risk threshold is less than the risk acceptability threshold, then the risk does not require mitigation. Otherwise, one or more treatments may be invoked to mitigate the risk. For each treatment applied to mitigate a risk, different combinations of local geographic configurations may be considered and given a normalized score on a 1-10 scale. For example, if two geographic configurations, Spanish and Japanese are possible for three different local geographic features—user interface, user support, and product documentation—then eight combinations may be considered. The highest revenue combination is assigned a score of 10 and the other combinations are assigned scores relative to the high score. When the score of a particular combination of geographic configurations/features for a risk treatment exceeds the risk acceptability threshold, then the risk may be mitigated by the corresponding treatment. The above-described approach may be repeated for each of the risks and each of the products in the product portfolio to generate product localization scores indicative of a percentage of the total risk mitigated. At block 425, a global localization score may generated by determining an average of the product localization scores for a particular combination of geographic configurations of the products. FIG. 10 illustrates an example where product localization scores are generated for each of the three products-Nimsoft, CLARITY, and Nimsoft Service Desk—and two geographic configurations are possible (i.e., Japanese and Spanish) for one local geographic feature-user interface. In the example shown, the combination with the greatest mitigation of risk is to translate the user interface for Nimsoft to Japanese, while translating the user interfaces for CLARITY and Nimsoft Service Desk to Spanish. It is understood, however, that a product may have multiple local geographic features that may be configured. Thus, based on the global localization score list, such as the one shown in FIG. 10, a table may be generated as shown in FIG. 11, which provides a determination of how to configure the local geographic features for each of the products. Assuming, for example, that three local geographic features are defined as a user interface, user support, and product documentation and represented with the labels, 1, 2, and 3, respectively, then the table of FIG. 11 indicates that product X should have both its user interface and user support translated into language A (level two localization) and its user interface translated into language B (level one localization). Product Y should have its user support translated into language A (level one localization) and all three local geographic features—user interface, user support, and product documentation-translated into language B (level three localization). Product Z should have its product documentation translated into language A (level one localization) and no translations performed into language B.

Some embodiments of the inventive subject matter may provide a DSS that can assist the users in determining how to configure a product or series of products for local service based on multiple criteria as described above. The DSS may allow description of priorities for the product(s) from multiple perspectives of an enterprise, such as financial, legal, and technical. Technical perspectives may include, for example, localization engineers' and linguists' perspectives. The DSS may take into account the joint effect of these priorities using a risk based methodology. The risks involved in a localization strategy may be assessed in light of the demands of the enterprise from multiple perspectives and a strategy for configuring local geographic features of the products may be generated that mitigates identified risks at a desired level. Embodiments of the inventive subject matter may, therefore, simply the complexity of generating and implementing a localization strategy for a product portfolio and ensure that important factors, such as priorities, risks, risk mitigating treatments, and the like are not overlooked in the process. As a result, embodiments of the inventive subject matter may provide a time savings for enterprise management, may ensure that multiple perspectives and voices are allowed to provide input in a localization strategy for a product portfolio, may assist in distributing a budget allocated for localization of products in the enterprise, and may provide an automated system for learning and documenting past decisions, which may be used to improve future localization decisions.

### FURTHER DEFINITIONS AND EMBODIMENTS

In the above-description of various embodiments of the present disclosure, aspects of the present disclosure may be illustrated and described herein in any of a number of patentable classes or contexts including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “circuit” “module,” “component,” or “system.” Furthermore, aspects of the present disclosure may take the form of a computer program product comprising one or more computer readable media having computer readable program code embodied thereon.

Any combination of one or more computer readable media may be used. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB.NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods, and computer program products according to various aspects of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular aspects only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Like reference numbers signify like elements throughout the description of the figures.

The corresponding structures, materials, acts, and equivalents of any means or step plus function elements in the claims below are intended to include any disclosed structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The aspects of the disclosure herein were chosen and described in order to best explain the principles of the disclosure and the practical application, and to enable others of ordinary skill in the art to understand the disclosure with various modifications as are suited to the particular use contemplated.

What is claimed is:

1. A method comprising:
performing operations as follows on a processor:
receiving a description of a plurality of products, each product in the plurality of products having a local geographic feature that is configurable in one of a plurality of geographic configurations;
receiving a description of priorities associated with the plurality of products;
generating a risk based on the priorities;
generating a risk mitigating treatment based on the risk;
generating, for each of the plurality of products, a plurality of product localization scores corresponding to the plurality of geographic configurations, respectively, each of the plurality of product localization scores indicating a relative amount of the risk mitigated by the risk mitigating treatment with the local geographic feature having the respective geographic configuration;
generating a plurality of global localization scores based on the plurality of product localization scores, each of the plurality of global localization scores corresponding to the plurality of products having one of a plurality of combinations of the geographic configurations; and
determining how to configure the local geographic feature for each of the plurality of products based on the plurality of global localization scores.

2. The method of claim 1, wherein the description of priorities comprises a description of market priorities associated with the plurality of products and a description of technical priorities associated with the plurality of products.

3. The method of claim 2, wherein the market priorities comprise product revenue, return on investment, customer loyalty, market reputation, and legal compliance.

4. The method of claim 2, wherein the technical priorities comprise quality of end user experience, difficulty of changing the local geographic feature from one of the plurality of geographic configurations to another one of the plurality of geographic configurations, and product maturity level.

5. The method of claim 1, wherein the plurality of geographic configurations comprises a plurality of human communication languages.

6. The method of claim 1, wherein each product in the plurality of products has a plurality of local geographic features, the plurality of local geographic features comprising:
a user interface;
user support; and
product documentation.

7. The method of claim 1, wherein the risk comprises a plurality of risks, the plurality of risks comprising breach of legal compliance, loss in customer trust, loss in brand name, loss in revenue in immediate financial year, loss in revenue in future financial years, and investment in a saturated market.

8. The method of claim 1, wherein the risk mitigating treatment comprises a plurality of risk mitigating treatments, the plurality of risk mitigating treatments comprising: ensure that market leadership is maintained, ensure that expected revenue in immediate financial year is greater than a first threshold, ensure that revenue in future financial years is greater than a second threshold, ensure that investment in configuring the local geographic feature is less than a third threshold, ensure that product maturity level is greater than a fourth threshold, and ensuring that investment in configuring the local geographic feature is less than a fifth threshold in a saturated market.

9. The method of claim 1, further comprising:
receiving a risk acceptability threshold for each of the plurality of products having the local geographic feature in each of the plurality of geographic configurations;
receiving a first indication of the likelihood of the risk occurring and a second indication of the consequence resulting from the risk occurring;
determining an importance of the risk threshold based on the first indication of the likelihood of the risk occurring and the second indication of the consequence resulting from the risk occurring; and
wherein generating, for each of the plurality of products, the plurality of product localization scores corresponding to the plurality of geographic configurations, respectively, is performed responsive to the importance of the risk threshold exceeding the risk acceptability threshold.

10. A system, comprising:
a processor; and
a memory coupled to the processor and comprising computer readable program code embodied in the memory that when executed by the processor causes the processor to perform operations comprising:
receiving a description of a plurality of products, each product in the plurality of products having a local geographic feature that is configurable in one of a plurality of geographic configurations;
receiving a description of priorities associated with the plurality of products;
generating a risk based on the priorities;
generating a risk mitigating treatment based on the risk;
generating, for each of the plurality of products, a plurality of product localization scores corresponding to the plurality of geographic configurations, respectively, each of the plurality of product localization scores indicating a relative amount of the risk mitigated by the risk mitigating treatment with the local geographic feature having the respective geographic configuration;
generating a plurality of global localization scores based on the plurality of product localization scores, each of the plurality of global localization scores corresponding to the plurality of products having one of a plurality of combinations of the geographic configurations; and
determining how to configure the local geographic feature for each of the plurality of products based on the plurality of global localization scores.

11. The system of claim 1, wherein the description of priorities comprises a description of market priorities associated with the plurality of products and a description of technical priorities associated with the plurality of products.

12. The system of claim 2, wherein the market priorities comprise product revenue, return on investment, customer loyalty, market reputation, and legal compliance.

13. The system of claim 2, wherein the technical priorities comprise quality of end user experience, difficulty of changing the local geographic feature from one of the plurality of geographic configurations to another one of the plurality of geographic configurations, and product maturity level.

14. The system of claim 1, wherein the plurality of geographic configurations comprises a plurality of human communication languages.

15. The system of claim 1, wherein each product in the plurality of products has a plurality of local geographic features, the plurality of local geographic features comprising:
a user interface;
user support; and
product documentation.

16. The system of claim 1, wherein the risk comprises a plurality of risks, the plurality of risks comprising breach of legal compliance, loss in customer trust, loss in brand name, loss in revenue in immediate financial year, loss in revenue in future financial years, and investment in a saturated market.

17. The system of claim 1, wherein the risk mitigating treatment comprises a plurality of risk mitigating treatments, the plurality of risk mitigating treatments comprising:
ensure that market leadership is maintained, ensure that expected revenue in immediate financial year is greater than a first threshold, ensure that revenue in future financial years is greater than a second threshold, ensure that investment in configuring the local geographic feature is less than a third threshold, ensure that product maturity level is greater than a fourth threshold, and ensuring that investment in configuring the local geographic feature is less than a fifth threshold in a saturated market.

18. The system of claim 1, wherein the operations further comprise:
receiving a risk acceptability threshold for each of the plurality of products having the local geographic feature in each of the plurality of geographic configurations;
receiving a first indication of the likelihood of the risk occurring and a second indication of the consequence resulting from the risk occurring;
determining an importance of the risk threshold based on the first indication of the likelihood of the risk occurring and the second indication of the consequence resulting from the risk occurring; and
wherein generating, for each of the plurality of products, the plurality of product localization scores corresponding to the plurality of geographic configurations, respectively, is performed responsive to the importance of the risk threshold exceeding the risk acceptability threshold.

19. A computer program product, comprising:
a tangible computer readable storage medium comprising computer readable program code embodied in the medium that when executed by a processor causes the processor to perform operations comprising:
receiving a description of a plurality of products, each product in the plurality of products having a local geographic feature that is configurable in one of a plurality of geographic configurations;
receiving a description of priorities associated with the plurality of products;
generating a risk based on the priorities;
generating a risk mitigating treatment based on the risk;
generating, for each of the plurality of products, a plurality of product localization scores corresponding to the plurality of geographic configurations, respectively, each of the plurality of product localization scores indicating a relative amount of the risk mitigated by the risk mitigating treatment with the local geographic feature having the respective geographic configuration;
generating a plurality of global localization scores based on the plurality of product localization scores, each of the plurality of global localization scores corresponding to the plurality of products having one of a plurality of combinations of the geographic configurations; and
determining how to configure the local geographic feature for each of the plurality of products based on the plurality of global localization scores.

20. The method of claim 19, wherein the plurality of geographic configurations comprises a plurality of human communication languages.
